(19) United States
(12) Patent Application Publication
(10) Pub. No.: US 2011/0088152 A1
(43) Pub. Date: Apr. 21, 2011

(54) FireSafety Cushion or Pillow

(76) Inventors: Enoch Y.S. Wang, Richmond (CA); Linda M.P. Hu, Richmond (CA); Solomon Hsiu-Kung Wang, Richmond (CA)

(21) Appl. No.: 12/581,132

(22) Filed: Oct. 17, 2009

(51) Int. Cl. A62B 17/00; B65D 85/18; F17C 13/00

(52) U.S. Cl. 2/458; 206/278; 220/560.01

(57) ABSTRACT

The FireSafety Cushion or Pillow is a compact, cushion-like packet with a thinly padded surface of fire retardant material. It contains a poncho-like flame-resistant safety-wear of light to heavyweight flame-resistant material to be worn as a protective outer cover in an emergency to help reduce injuries from flash flames. It may contain other fire escape aids, such as ropes and masks, as options. It is to be placed in living areas, either public or private as a scatter pillow or an attachment to seats or bedboards etc., making it readily available in case of fire. The cushion or pillow should be easily detachable, so that a person can grab it on the run because every second counts in case of fire. This is to provide a much needed safety measure for a common hazard.

### THE DISTINCTIVE FEATURES OF THE INVENTION

1) Readily Available

Unlike other fire protective wear, which are usually put away in storage, FireSafety cushion or pillow is placed in the open living space as part of the décor or the seat or be, that is, wherever people sit or sleep. The fact that it is right at hand will give the precious seconds/minutes that saves a life in case of fire.

2) Affordable

The design is to be compact and simple, so as to cut down the cost to reach the general public. It is hoped that the price in mass production can be so affordable that all public transport or facilities will be willing to provide it for the safety of their customers. Note: the design is for fire escape, not for firefighting.

### BACKGROUND OF THE INVENTION

According to USFA “national Fire Statistics, nationally, there are millions of fires, thousands of deaths and injuries, and billions of dollar loss—which makes the U.S. fire problem one of great national importance. Between 1999 and 2008, there was an average of 1,634,150 fires, resulting in an estimated $11,634,800,000 in direct dollar loss each year. An average of 3,625 Americans lost their lives and another 18,765 were injured annually as the result of fire. These averages do not reflect the events of Sep. 11, 2001”.

Even though people are aware of the devastation of fire, few people, other than professionals, are prepared for sudden fire eruptions. Modern advances have created many environments which magnify fire hazards. Although statistics show almost equal number of deaths from fire per year as those from drowning, we see only the widespread provision of life jackets, but nothing for personal protection from fire. This is what prompted the present invention.

### OBJECT OF THE INVENTION

It is the inventor's intention to introduce an affordable, lightweight and compact fire protective wear that can be packaged into a small cushion-like packet that can be placed anywhere there is a seat or bed so as to make instantly accessable the much needed basic protection from fire.

It is envisioned that all public lounges, transportation vehicles would have these packages imbedded into the seats as a public safety measure. The cushion or pillow could function as part of the filling for the seat. Just as the lifejackets are now stowed away under the seats, so also, these cushions or pillows can be attached to the seats with Velcro or other fasteners to seats, functioning as back support or headrest. They can be placed on headboards in a hotel or cruise ship beds. They should be recognizable and easily detachable and grabbed at a moment's notice, whenever fire is detected. Concerned people, especially those living or working in a hard to reach high-rise building may obtain for themselves such a cushion for their favorite chair or bed. People can have a number of these scattered in places where they frequent, such as their cars, their workshops, kitchen or family room.

### DESCRIPTION OF THE INVENTION

The design of the cushion or pillow can be varied. The one constant factor is an easy-to-open pocket that contains a folded poncho-like flame resistant safety-wear of light to heavyweight, flame-resistant material, plus other options to be specified by manufacturers according to the needs of their targeted clientele.

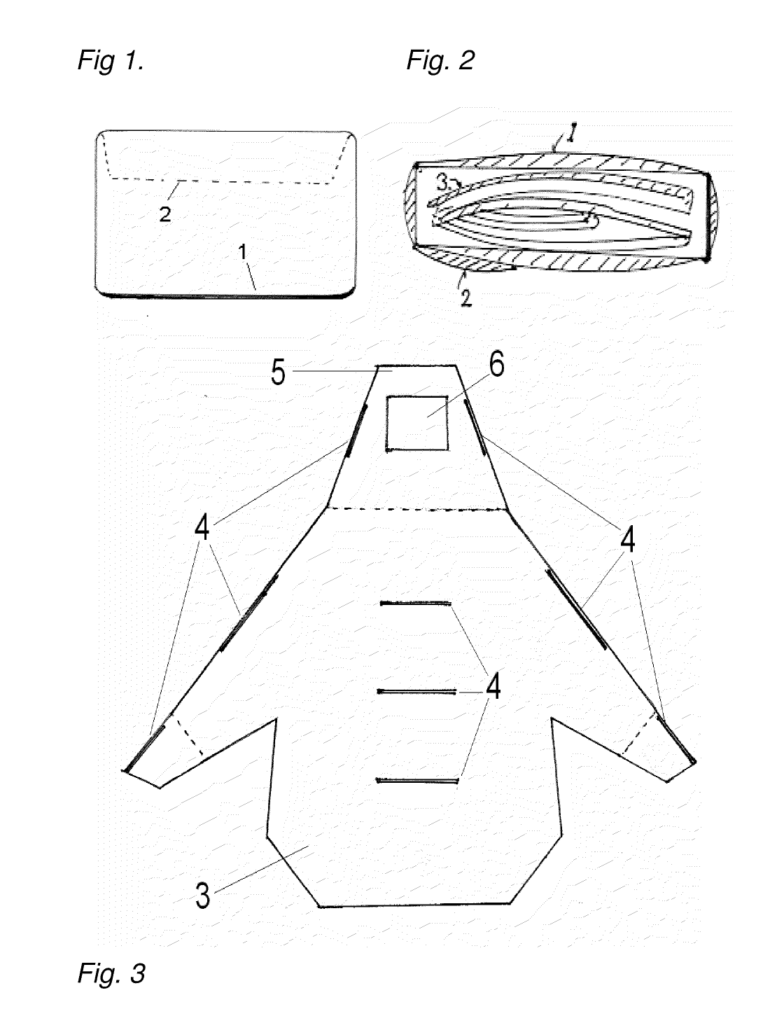

FIG. 1 is a top view of the FireSafety cushion. FIG. 2 is a cross-section view of the FireSafety cushion in FIG. 1. The outer shell of the cushion or pillow 1 should be at least flame retardant. It should have a thinly padded surface. The padding of the cushion 1 should be water absorbent. In case of fire, the absorbent padding of the cushion 1, when wetted, can double as a filter, cooling the temperature of the air breathed in and filtering some smoke. Even when dry, the padding of the cushion 1 can also help filter out some heat and smoke. The cushion's design should be dictated by the needs of the customer, such as airlines, coaches, cruise ships, home furnishing stores, etc, especially if they are to be attached to the seats as part of the headrest or backrest. The cushion or pillow itself can also become useful as a protective flame block for the head when running through a wall of flames. It may or may not have a flap 2 for closure of the packet.

The design of the poncho-like safety wear 3 placed inside the packet can be customize according to the needs of the clientele. FIG. 3 shows the front elevation of the poncho-like safety wear. In general, it should be just one piece poncho and easy to put on. It should cover the arms up to fingers, the torso up to the knees, the face neck and head. A fire-resistant, transparent reflective piece 6 in the hood 5 is provided for the eye area. Basically, the poncho consists of ±2 square meters of fire resistant material, such as the 7 oz or 11 oz Firewall™ FR fabrics (please see www.firewallfr.com for specifications), The cutting should be simple and should take into consideration, maximum usage of material (please refer to FIG. 3). The design can be modified for special needs and future improvements). Cost effectiveness is of primary importance. The aim is to make the product affordable for the general public. To help rescuers to see the escaping person, reflective material 4 (such as 3M (scotchlite™) or others, should be attached to help mark the torso, arms, head etc; all parts that move.

The material of the poncho must be professionally-treated, fire resistant material (such as Firewall™ FR) of light to medium weight that meets NFPA standards or other similar standards of various countries. The standards may vary according to the needs of the surrounding environment. The protective properties of the poncho material could be graded and indicated on the package to facilitate customer choice.

The marketing of the FireSafety-Cushion: The cost of the cushion or pillow should be within reach of the general public. This low-cost, simple but functional fire protection packet, takes the item out of the specialized fire safety market. As a cushion or pillow, it can enter into any department store, supermarket, furniture store, and be considered by major builders of cruise lines, trains, buses etc. for the safety of their customers. It is a very little price to pay for a great sense of security and care. But in case of special professional needs, such as military, high hazard occupations, the requirements maybe more stringent, hence more costly.

What is claimed:

1. FireSafety Cushion or Pillow is a compact and easy to open cushion-like packet with a pocket to contain a fire protective garment and other fire escape aids (i.e. masks and ropes) as options, can rest unobtrusively in any living area, to be where it is needed, providing the user many precious seconds in case of fire, which may mean the difference between life or death.

2. Folded and placed inside the pocket of the cushion is a one-piece, easy to slip on, poncho-like, fire-resistant protective garment, made of fire-resistant material, consisting of a hood with fire-resistant, reflective eyepiece, and arms with cuffs to reach the fingertips and torso to cover at least the knees, to be worn as a protective outer cover in an emergency, to help reduce injuries from flash flames.

3. The cushion or pillow should blend into the décor of any living space either as an independent cushion or pillow or be attached to, or serves as functioning part of a seat or bed, or other furniture pieces placed in a private home or public area so as to become part of a person's daily life, readily available in an emergency at a moment's notice.

4. The cover material of the cushion or pillow in claim 1 could be of any flame retardant/resistant material of any color or weave or pattern.

5. The padding of the cushion or pillow in claim 1 could be of any water absorbent material, and in case of fire, the absorbent padding, whether wet or dry, can double as a filter.

6. The material of the one-piece, poncho-like garment in claim 2 can be of any fire-resistant material or varying weight, to meet different needs and standards.

7. The reflective eyepiece in claim 2 can be of any flexible transparent material that is fire retardant/resistant.

8. The hooded poncho in claim 2 should have luminous reflective markers to be attached on to the moving parts of the poncho and these should be of any fire resistant material such as 3M™ (Scotchlite™) or others.

9. The design of the single-piece poncho-like fire safety wear in claim 2, can be customize and made in various sizes according to the needs of the clientele.

10. The design of the cushion or pillow in claim 3 can be made to accommodate the design of any furniture or décor, provided there is room for the FireSafety garment, and is easily detachable from the furniture, and has a convenient opening for quick removal of the garment.

11. The grade or degree of protection of the fire-resistant poncho in claim 2 is dependent on the fire-resistant material employed, and could be of various grades or standards which can be customize according to the needs of the clientele.

12. The purpose of the hooded poncho in claim 2 is primarily to provide a ready at hand fire protective wear that can be grabbed on a run at a moment's notice, gaining precious seconds that may save a life, and in case of bad weather, the strong material of the poncho will also provide certain degree of warmth and shield the person from rain and snow.

13. The purpose of the FireSafety Cushion or Pillow in claim 1 is primarily to make the functional packet to contain a FireSafety poncho, and blend in to any living area so that it can be part of a person's daily life where it is needed without being obtrusive and be a useful article at the same time.

14. The Cushion or Pillow in claim 1, in case of fire, can double as a filter for breathing, a flame block for dashing through flames, and a cushion for sliding down banisters or ropes.
